(19) United States
(12) Patent Application Publication
(10) Pub. No.: US 2020/0214060 A1
(43) Pub. Date: Jul. 2, 2020

(54) ESTABLISHMENT OF A LINK FOR EXCHANGING IP PROTOCOL DATA BETWEEN IMPROVED BASE STATIONS BY DIRECT COMMUNICATION

(71) Applicant: Air Lynx, Les Ulis (FR)

(72) Inventors: Laurent PISON, Jouars Pontchartrain (FR); Didier RAFFENOUX, Orsay (FR)

(21) Appl. No.: 16/728,399

(22) Filed: Dec. 27, 2019

(30) Foreign Application Priority Data
Dec. 30, 2018 (FR) 1874389

(51) Int. Cl. H04W 76/14; H04W 88/06; H04W 48/16; H04W 72/04; H04W 88/08; H04W 80/04; H04W 92/20

(52) U.S. Cl. CPC H04W 76/14; H04W 88/06; H04W 48/16; H04W 92/20; H04W 88/08; H04W 80/04; H04W 72/0426; H04W 72/042

(57) ABSTRACT

The present invention relates to the field of radio communication systems with mobiles based on LTE cellular technology. The invention relates in particular to the establishment of direct mode links between the base stations of mobile structures, for exchanging IP protocol data instead of conventional links via the fixed equipment of the network core. To this end, it is proposed to divert radio resources originally intended for the communications established between a base station and mobile communication terminals via the LTE-Uu interface, in order to use them for establishing direct mode links via specific link entities equipping each of the mobile structures concerned.

### CROSS-REFERENCE TO RELATED APPLICATIONS

This specification is based upon and claims the benefit of priority from French patent application number FR 1874389 filed on Dec. 30, 2018, the entire contents of which are incorporated herein by reference.

The present invention generally relates to radio communication systems based, for example, on LTE cellular technology. In particular, it relates to the establishment of links for transporting IP protocol data between base stations, for example on mobile structures, in order to limit interference. In particular, it relates to a direct communication system between mobile structures in such a network.

### Prior Art

Mobile telecommunications networks, such as cellular networks according to the LTE (“Long Term Evolution”, according to an Anglo-Saxon terminology) standard defined by the 3GPP consortium and its evolution LTE-A (“Advanced LTE”, according to Anglo-Saxon terminology), allow to establish high-throughput communications between mobile terminals, with a low latency and a high tolerance for the relative movements of the various mobile entities forming the network. The architecture of these networks is generally based on a set of base stations, called eNodeBs (from the English, “evolved Node B”) in LTE standard, which are fixed network nodes forming the radio part of the network, called eUTRAN in LTE standard, and which establish wireless communications with mobile terminals, called UEs (from the English, “User Equipment”) in LTE standard, via a specific radio interface, called Uu interface in LTE standard. The radio part of an LTE network consists in eNodeBs, local or remote antennas, optic fiber links to remote antennas (links of the CPRI (for “Common Protocol Radio Interface”) type, for example) and IP links (for “Internet Protocol”, according to an Anglo-Saxon terminology) connecting the eNodeBs with each other (X2 interface) and with the network core (S1 interface) via a backhaul network.

The LTE standard is compatible with the concept of a mobile cell, according to which a base station can itself be mobile, as installed in a mobile structure (for example, a fire brigade vehicle, or a vehicle of the “command-car” type of security forces, for example), in order to be able to project anywhere in a territory an LTE cell capable of serving a group of LTE mobile terminals used by police officers, firefighters, etc.

The exchanges between base stations or between UEs taking place within the network must necessarily pass through the core of the network, called the EPC (from the English, “Evolved Packet Core”) in LTE standard. In other words, the base stations and the UEs of the network cannot communicate directly with each other, but only through the LTE interfaces, via the EPC.

In some cases, however, it may be desirable to establish a communication link between two given pieces of equipment of the network without passing through a common network core, especially if the link between a base station and the network core is lost or non-functional. A typical use case is, for example, that of security and rescue forces (police, fire brigades, ambulances, etc.) which must be able to collaborate and communicate with each other following, for example, a natural disaster, such as an earthquake or a tidal wave, with the immediate consequence that the shore-based communication facilities participating in the communication network are shut down. There is therefore a need for a solution for setting up IP protocol data exchange links between stations to compensate for the failure of the standard network and/or equipment of the network core.

In summary, especially, but not only, in the context mentioned above, it may be useful for specific applications to establish communication links between base stations, or node, in order to make the data exchanges between these base stations autonomous with respect to the rest of the standard network.

The French patent FR 3033121 discloses a base station comprising a radio interface module adapted to transmit and receive radio frequency data, and a pilot block adapted for establishing a communication link and communicating on said link with at least a first user terminal in accordance with a radio protocol comprising a radio protocol section specific to the base stations and a radio protocol section specific to the user terminals, by using said radio interface module. The base station is characterized in that it further comprises a management unit adapted to create a plurality of virtual user terminals adapted to communicate in accordance with said radio protocol with base stations neighboring said base station, by using said radio interface module. Such a base station allows to create a mesh network of base stations, and to transmit data directly between base stations according to, for example, the LTE-Uu interface protocol for LTE base stations (namely, eNodeBs).

In such a system, however, when a base station communicates with a virtual terminal associated with a neighboring base station, it does so on the same frequency band as the one it already uses to communicate with the mobile terminals in its mobile cell. In other words, the different base stations that are connected to each other within the mesh backhaul network thus formed, use the same frequency spectrum for exchanging data with each other as the frequency spectrum used for cellular communications with the mobile terminals in their respective mobile cells. In addition, these cellular communications are all through radio interface modules which are themselves identical, namely the LTE-Uu interface and the LTE-Un interface (which is an interface dedicated to relays, where appropriate).

As a result, the risk of interference between radio links is high. Indeed, the operation of cellular communications with user mobile terminals within the cell associated with a first given mobile structure may be disrupted by the backhaul-type radio links established between virtual terminals associated with the base station covering this mobile cell, on the one hand, and a base station belonging to another mobile structure, on the other hand.

### Technical Problem

The invention aims to overcome the disadvantages of the prior art. In particular, the invention aims to provide a communication system, said system being capable of establishing a backhaul-type network allowing an IP protocol communication for connecting the IP applications and services of the mobile structures. In addition, this method must allow the link to be set up quickly and with a reduced risk of interference, and this despite putting in communication several mobile structures, while still allowing to operate on the available spectrum. The invention also aims to provide a method capable of establishing an IP protocol data transport link between at least two improved base stations, said link allowing a backhaul-type network for an IP protocol communication for connecting the IP applications and services of remote structures and not connected by a wired communication network.

### BRIEF DESCRIPTION OF THE INVENTION

To this end, a first aspect of the invention provides a communication system comprising at least two improved base stations each having mobile communication terminals and at least one base station which is adapted for establishing cellular communication links with said mobile communication terminals of the improved base station via a determined radio interface by allocating radio resources to said cellular communication links among a set of available radio resources, wherein each improved base station further comprises a link entity configured to establish a direct mode link with the link entity of the other improved base station; and wherein the base station of one improved base station at least is configured to exclude from the allocation to cellular communication links, part of the available radio resources, and to assign radio resources thus excluded to the allocation to a direct mode link established with the base station of the other improved base station through the respective link entities of said improved base stations, for exchanging IP protocol data between said base stations, via a radio interface separate from the radio interface used for the cellular communication links.

The invention thus allows to use part of the radio resources available to the eNodeB of an advanced base station of an improved base station for communicating with terminals present in its cell, in order to establish direct mode links between the corresponding improved base station and one or more other improved base stations. A backhaul network between different improved base stations can thus be established, where appropriate with a mesh topology, for example, through link entities provided in each of the improved base stations concerned, which can be terminals specifically dedicated to these direct mode links. Thus, the invention provides an alternative based on the establishment of direct mode links between base stations using a common frequency spectrum, in order to create a backhaul network for exchanging IP protocol data between said base stations, and thus allows to do without the fixed infrastructure of the standard network and this without using any ancillary technology (for example, wimesh). In addition, it is not necessary to dedicate a specific spectrum to the backhaul and it is the same spectrum on all nodes or improved base stations. The link entity allows to avoid interference problems. Preferably, the improved base stations of the system according to the invention are not connected by a wired communication network.

In addition, such a system can integrate without modification most of the techniques allowing coverage or throughput gains for the communication technology used such as, for example, in the case of LTE, MCS (for “Modulation Code Scheme”, in Anglo-Saxon terminology) and MIMO (for “Multiple Input Multiple Output”, in Anglo-Saxon terminology). Similarly, different modes such as TDD or FDD duplex of the LTE are supported.

According to Other Optional Features of the Communication System:
The radio interface is selected from any radio interface for allocating radio resources comprising Radio Blocks. Indeed, the present invention will be described in the context of an LTE-type communication, but it can be applied to many other protocols such as those allowing for cellular communication links, for example those responding to an OFDM (for “Orthogonal frequency-division multiplexing”, in Anglo-Saxon terminology) coding or a derived coding such as OFDMA or SC-FDMA (for “Orthogonal Frequency-Division Multiple Access” and “single-carrier frequency division multiple access”, in Anglo-Saxon terminology). The Radio Blocks can be as defined in the LTE standard of the 3GPP consortium. This advantageously allows to facilitate the segmentation of the resources, especially to dedicate only part of said Radio Blocks to the mobile terminals (Uu communication) as a function of time. Thus, preferably, all or part of the Radio Blocks originally dedicated to UL (UpLink) or DL (DownLink) data transfer for users of the Uu type (LTE) from a base station are assigned to the direct mode link.
it comprises an improved base station, the link entity of which is a link terminal with hardware resources and software resources of its own. Thus, the direct mode link may be more powerful in order, for example, to reach remoter structures or base stations or to increase the amount of data that can be exchanged between the improved base stations. In addition, it allows to reuse the existing technology and does not require the integration of a complex coding technology to manage the interference.
it further comprises an improved base station, the link entity of which is a link terminal comprising software resources implemented in the base station of said improved base station, as well as hardware resources of said base station. It is then not necessary to have an additional device dedicated to establishing the direct mode link. In this case, preferably, the hardware resources may include an antenna, the power of which dedicated to the improved base station will be greater than the power dedicated to the communications with the mobile terminals. The link entity may also be a virtual terminal comprising exclusively software resources implemented in the base station of said improved base station, as well as hardware resources of said base station. Thus, it does not require any additional hardware resources on the radio relay except for a smartphone or a radio modem.
the radio interface used for establishing a direct mode link between the base station of one improved base station and the base station of the other improved base station via the respective link entities of said improved base stations, comprises radio resources diverted from the downlink channels of the radio interface used for the cellular communication links. This allows to optimize the use of the available resources and thus the amount of information exchanged via the direct mode link is greater, especially thanks to an increase in the available throughput and/or to the increase in the data transport links.
one base station of each improved base station is configured to establish direct mode links with the respective base stations of a plurality of other improved base stations, via the respective link entities of said improved base stations.
the link entities of the plurality of improved base stations can form with each other a backhaul network for establishing a mesh topology.
one base station of an improved base station is configured to establish a direct mode link with the respective base stations of a plurality of other improved base stations, via the respective link entities of said improved base stations, in a multicast configuration. In this way, signaling between link entities can be facilitated and improved.
it comprises radio resources of the base station of an improved base station which are excluded from the allocation to cellular communication links with mobile communication terminals of said improved base station, which are subdivided into at least two, preferably at least three, sets of radio resources, which may be allocated for each set of radio resources to direct mode links with the base station of a respective one of the other improved base stations. These direct mode links with the base station of one respective of the other improved base stations are, in particular, through the link entities. Thus, the resource format of the communication technology used is reused without impact on the user terminals using Uu-type communications.
the links between the respective base stations of improved base stations which are established in direct mode via the link entities of said improved base stations, are used in half duplex mode (in English, “half duplex”) with symmetrically or asymmetrically sharing the transmission and reception time for each link entity. For example, time sharing may be asymmetrical at a ratio of one third of the time for transmission to two thirds of the time for reception. Such sharing allows to improve the “actual time” required to transmit data between a base station and a remote entity. Alternatively, the links between the respective base stations of improved base stations which are established in direct mode via the link entities of said improved base stations, are used in full duplex mode via two half duplex links between the same improved base stations.
an improved base station further comprises a control entity which is configured to control the allocation, by the base station of said improved base station, of the radio resources of said base station both for the cellular communication links with mobile communication terminals of the improved base station by using the radio interface of said base station, and for a direct mode link for exchanging IP protocol data with the base station of at least one other improved base station.
At least one of the improved base stations is placed on a mobile structure, preferably each of the improved base stations is placed on respective mobile structures. Since the system allows to establish a link between base stations without the necessary wired backhaul, it is particularly well suited to systems including mobile or nomadic structures (vehicle, drone . . . ). Thus, preferably, the system according to the invention comprises a mobile structure comprising an improved base station that comprises the base station and the link entity of the improved base station.

According to another aspect, the invention relates to a method for establishing a link for exchanging IP protocol data between respective base stations of improved base stations each having mobile communication terminals and at least one base station which is adapted for establishing cellular communication links with mobile communication terminals of the improved base station via a determined radio interface by allocating radio resources to said cellular communication links among a set of available radio resources, said method comprising the following steps:
transmitting by a link entity of a first improved base station, a first identification/authentication message destined to a link entity of a second improved base station, said message being transmitted by using radio resources of the base station of the first improved base station which belong to a part (and only a part) of the radio resources of the base station of the first improved base station which are excluded from the allocation by said base station to cellular communication links with mobile communication terminals of said improved base station;
receiving, by the link entity of the first improved base station, a second identification/authentication message which is transmitted in response by the link entity of the second improved base station by using radio resources of a base station of the second improved base station which are excluded from the allocation by said base station to cellular communication links with mobile communication terminals of the second improved base station;
transmitting, by the link entity of the first improved base station, the second identification/authentication message to a control entity of the first improved base station and verifying by said control entity the validity of the data associated with said second identification/authentication message; and, in case of validity,
establishing a direct mode link between the base station of the first improved base station and the base station of the second improved base station, through the respective linking entities of said first and second improved base stations, for exchanging IP protocol data between said base stations, by using radio resources, of the base station, which are excluded from the allocation by said base station to cellular communication links with mobile communication terminals of said improved base stations.

According to Other Optional Features of the Method:
It comprises, before the step of transmitting a first identification/authentication message, a step of transmitting a discovery message, for example in multicast mode, with the following steps being initiated upon receipt of a response from another improved base station. In particular, this step may be repeated periodically until a response is received.
during the step of establishing the direct mode link, sharing the transmission and reception time for each link entity is established. This sharing may be symmetrical or asymmetrical and preferably asymmetrical.
the identification/authentication messages exchanged between link entities are based on data contained in HSS-type databases of local EPCs respectively included in improved base stations of the first and second mobile structures which comprise the base station and the mobile communication terminals of said first and second mobile structures, respectively.

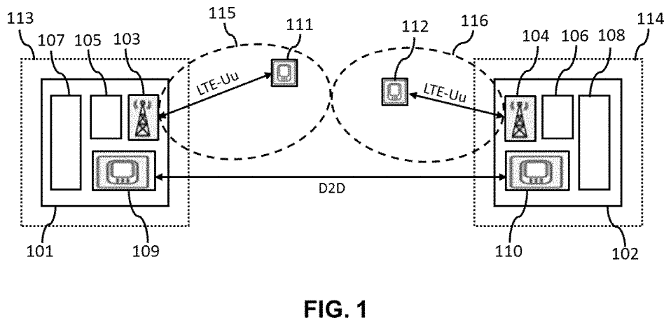

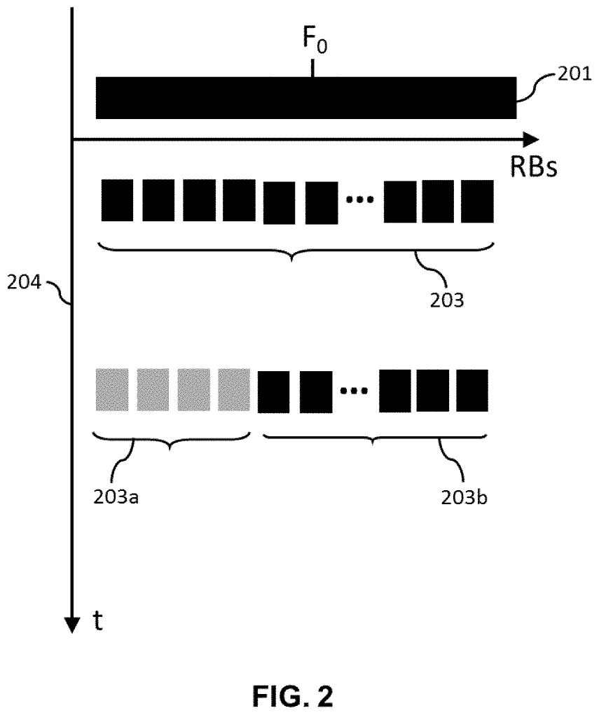

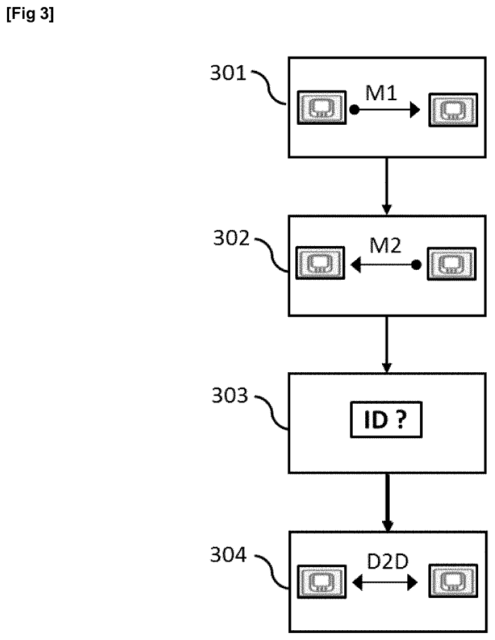

Other advantages and features of the invention will appear upon reading the following description given by way of an illustrative and non-limiting example, with reference to the figures in the appended drawings in which:

[FIG. 1] is a functional diagram illustrating an embodiment of a direct communication system between two mobile structures according to the invention;

[FIG. 2] is a diagram illustrating the distribution of the radio blocks used for the communications according to the embodiments of the invention, knowing that these radio blocks are not necessarily contiguous and not necessarily complete; and,

[FIG. 3] is a diagram of the steps of a mode for implementing the method according to the invention.

### DESCRIPTION OF THE INVENTION

With reference to the diagram in FIG. 1, it will firstly be described an embodiment of a mobile radio communication system with mobile structures according to the invention.

The terms “mobile structure” refer to an entity that comprises means of cellular communication with user terminals belonging to the mobile structure, and which is itself mobile, that is to say it can be in motion, stationary (namely, not mobile) or nomadic (namely, alternating mobility phases and stationary phases).

The mobile structures can correspond, more generally, to any fixed land and/or naval infrastructure, that is to say with no material means adapted to move, or to any land and/or naval structure mobile with means adapted to move, stationary (namely, not mobile) or nomadic (namely, alternating mobility phases and stationary phases). Advantageously, the mobile structures according to the invention are not connected by wire links.

The term “direct”, generally used in reference to modes of communication between two entities, means that no intermediate entity is involved in these communications for transporting data between the transmitting entity and the receiving entity. When used in particular with reference to a mode of communication between mobile structures such as defined above, the term “direct” means that the transport of data between two mobile structures is without the intervention of the network core through which these mobile structures normally establish their communications.

In the example shown in FIG. 1, the mobile structures 113 and 114 are each equipped with improved base stations 101 and 102. These improved base stations 101 and 102 each comprise at least one base station 103 and 104, respectively, such as for example the entities called eNodeB (from the English, “evolved Node B”) in the context of LTE systems. Each of the improved base stations 101 and 102 also comprises a core of a local network 105 and 106, respectively, such as, for example, a core of a network called EPC (from the English, “evolved Packet Core”) in LTE standards. Finally, each of the improved base stations 101 and 102 comprises a control entity 107 and 108 called RRCE (for “Radio Resource Coordination Entity”, in English) and a dedicated link terminal 109 and 110, respectively, such as a terminal called dUe (for “dedicated User Equipment”, in English) in the context of LTE systems. As will be explained in more detail below, these link terminals are specifically dedicated to the establishment of at least one backhaul-type link between the two improved base stations 101 and 102 serving the mobile structures 113 and 114, respectively.

In the cases of a stationary use, that is to say when such a mobile structure does not move, the advanced base station is able to communicate under IP protocol with fixed network equipment, through which it can exchange data with the advanced base station of another mobile system. When the mobile system is moving, but remains within radio range of such a fixed network piece of equipment, these communications are also possible and are therefore used.

Conversely, the links covered by the invention are links that are established, in accordance with embodiments, between mobile structures when they are moving and are located together at distances beyond the radio range of the on-board base stations with the fixed network equipment. Thus, for example, as will also be shown in more detail below, two vessels traveling on the high seas can, by implementing the invention, set up a direct communication link with each other. In addition, the example shown in FIG. 1 is not limiting, and the one skilled in the art will appreciate that the invention can be applied to a number of structures greater than or equal to two.

For example, the eNodeBs 103 and 104 integrated with the improved base stations 101 and 102, respectively, are, for example, base stations as commonly used in mobile radio networks based on the LTE standards of the 3GPP consortium. In a way known to the one skilled in the art, and in accordance with LTE standards, they constitute the gateway between the core of the LTE network for transporting data under IP protocol, on the one hand, and the mobile communication terminals, or user equipment UEs (from the English, “User Equipment”) 111 and 112, on the other hand. In particular, the eNodeBs serve geographical areas defined by the extent of their radio coverage. These geographical areas form the radio cells 115 and 116 within which radio communications are established between each eNodeB and the mobile communication terminals (namely, the UEs) 111 and 112 which are connected thereto by cellular communication links. For readability reasons, the two cells shown in FIG. 1 and associated with eNodeB 103 and eNodeB 104, respectively, comprise only one UE each. However, the one skilled in the art will, here again, appreciate that the number of mobile terminals present in each cell can obviously be greater than one.

Within a cell, the radio communications are on a determined frequency band (namely, a frequency spectrum), centered about a frequency F₀ and which has a determined spectral width, typically of several Megahertz. For example, a spectral width of 3, 5, 10, 15 or 20 Megahertz. In addition, in specific embodiments of the invention, each eNodeB can carry out its own radio exchanges on a specific frequency spectrum. Advantageously, but not restrictively, each eNodeB can carry out its own radio exchanges on a same specific frequency spectrum, common to each of said eNodeBs. However, in all cases, the frequency spectra used by the eNodeBs are those as defined by the LTE standard of the 3GPP consortium.

The eNodeB 103 and 104 use LTE-Uu radio interfaces to establish cellular communication links with all the UEs present in the cell they serve. The terminals present in the cells respectively associated with the different eNodeBs can therefore be standard LTE terminals. In other words, terminals that do not require any specific capacity to be used in this context. In particular, these terminals can be fully compatible with the LTE standards of the 3GPP consortium.

In addition, the eNodeBs 103 and 104 use LTE-S1 interfaces to communicate with the core of the EPC network by backhaul-type links. A backhaul-type link refers to a link used for connecting the core of an LTE network and the nodes (namely, the base stations) of that network. All of the links of this type form what is called an intermediate network, or backhaul network. These links can be wired (for example, by an optic fiber or a cable) or wireless (for example, by microwave link). The exchanges on these links are based on the IP protocol. In addition, the number of possible links is multiplied by the number of sectors available under the eNodeB. Indeed, one eNodeB can support several cells of the same frequencies F0 or several cells in each frequency F0 to Fn.

As for the local EPCs 105 and 106 included in each of the improved base stations 101 and 102, respectively, they integrate all the known functions related to the core of an LTE mobile network. In particular, they integrate MMEs (from the English, “Mobility Management Entity”), SGW (from the English, “Serving Gateway”) service gateways, PGW (from the English, “Packet Gateway”) data transport gateways and an HSS (from the English, “Home Subscriber Server”)-type database that contains most of the useful information related to the network users such as, for example, the location of a user and/or its identification/authentication.

The entities of the RRCE type 107 and 108, also included in each of the improved base stations 101 and 102, respectively, manage and control the use of the radio resources made by each advanced base station. Indeed, as will become apparent from the description given below, a single frequency spectrum is used by each improved base station both to establish the communications between the corresponding eNodeB base station and the UEs within the cell covered by that eNodeB, and to implement, where appropriate, a direct link, by a backhaul-type link, between two improved base stations of two respective separate mobile structures. The RRCEs therefore control the allocation of the radio resources (namely, their distribution) between, on the one hand, the LTE network as a whole and, on the other hand, direct backhaul-type links supporting the IP protocol between different mobile structures.

Finally, in addition to the entities already mentioned which are integrated into the improved base stations of each mobile structure, these also include dedicated user equipment or dUEs. As already mentioned above, the dUEs allow to establish direct backhaul-type links between two improved base stations. More precisely, these are links in direct mode, that is to say without an intermediary, called “device-to-device” and named D2D thereafter. Such direct links are made possible by the use of dedicated terminals of a particular type, namely the dUE link terminals already presented above, which are specifically adapted for this use. This is also referred to as direct mode communications. The connections used are of the point-to-point-type and, in the context of the invention, require a high power for establishing a connection between two mobile structures (therefore two improved base stations) that are potentially quite distant from one another. Typically, the dUEs are equipped with an antenna coupled to an amplifier, the power of which is of several tens of Watts, thus avoiding the need to add additional hardware resources compared to the equipment already used by the node (eNB). Thus, it is possible to use the eNB hardware such as the radio frequency and power processing unit, the antenna and the mast in the case of a vessel. For example, this power is greater than or equal to 10 Watts, preferably greater than or equal to 15 Watts, such as a power greater than or equal to 20 Watts.

Indeed, it is common for a base station, whether mobile or not, to include an antenna system with several antennas for transmitting/receiving radio frequency signals. Each, or a group, of all the antennas of the base station forming its antenna system can serve a radio coverage area, called a cell, that is specific thereto. In addition, since the antennas of such an antenna system are directional antennas, their respective radio coverage areas are subdivisions of the total radio coverage area of the base station. More particularly, these subdivisions are angular sectors of the total radio coverage area of the base station. This is then referred to as a multisector antenna system, with each antenna sector corresponding to a determined angular sector, and being served by a respective antenna or group of antennas of the antenna system. Since each antenna sector uses its own radio resources, especially one or more frequency bands each defined by a central frequency and a bandwidth, an antenna sector defines a cell in the radio sense. Each sector may also use a frequency common to one or more other angular sectors of the same node.

Typically, the antenna system of a base station of a mobile telecommunications network may consist in a plurality of antennas, each covering an angular sector, for example of 90°. The radio coverage area of such a base station therefore extends in all directions (namely, at 360°) around this base station with, for example, four portions of equal angular openings, of the total radio coverage area, covered by four different antennas, respectively. Consequently, the mobile communications terminals, located in the radio coverage area of a base station, establish a cellular communication link specifically with the antenna of the antenna system covering the specific angular sector in which they are located. In addition, the antenna system may also include other antennas for covering, beyond the horizontal plane, vertical sectors. The radio coverage area is then preferably defined in 3 dimensions.

In addition, when establishing a backhaul-type data transport link is carried out between the base station of a mobile structure and a dedicated user piece of equipment of a third party mobile structure, said link is done more particularly between the dedicated user piece of equipment of the third party mobile structure, on the one hand, and the antenna of the antenna system of the base station covering the precise angular sector in which it is located, on the other hand.

In summary, any radio communication link of a base station, that is to say both a cellular communication link and a backhaul-type data transport link, involves data exchanges between the entity (mobile communication terminal or dedicated user equipment, respectively) with which this link is established, on the one hand, and a single antenna of the antenna system of the base station, on the other hand, which is determined by the relative angular position of the entity with respect to the base station.

In case the base station is mobile (namely, in case it belongs to a structure that is itself a mobile structure), the spatial configuration of the radio communication links of said base station may change over time, sometimes significantly. Indeed, the spatial configuration of the radio communication links of a base station stems directly from the arrangement of all the entities located in its radio coverage area. Thus, when the mobile station is moving or when the entities with which it has established radio communication links are moving, the distribution of the radio communication links between the different antennas of the antenna system of a base station can vary significantly. For example, an entity may enter or exit an angular sector of the radio coverage area of the base station, by exiting or entering another angular sector, respectively. In addition, the number of entities, in a given angular sector, with which the base station is likely to establish a radio communication link may increase or decrease over time, sometimes substantially.

However, an entity, having a radio communication link with a base station, passing from the radio coverage area of one of its antennas to the radio coverage area of another of its antennas, may require complex and resource-consuming operations. All the operations allowing such an entity to pass from one cell to another without the radio communication link being interrupted are grouped under the name “handover” (or in French, “transfert intercellulaire”). Thus, the use of a base station in a mobile structure may involve complex and relatively frequent handovers, due particularly to the mobility of the base station.

In addition, during the handover of an entity from one of its cells to another of its cells, each base station must manage the allocation of radio resources made to this link in each cell to ensure its continuity. In other words, within the total frequency spectrum used by the base station for all its radio communication links, the control entity which supervises managing the radio resources and performing handovers must assign to each of its links, one or more frequency bands of this spectrum, which allows to maintain substantially identical capacities for this link, whatever the angular sector in which said link is actually established at all times.

In summary, the mobility of a base station with a multisector antenna system of a mobile structure generates an increased complexity in the management of the radio resources to take into account the actual needs of all the radio communication links established in all the different angular sectors of its radio coverage area. This complexity can be all the more disadvantageous in that, whatever the type of radio communication link concerned (cellular communication link or backhaul-type data transport link), changing their spatial configuration can be frequent.

The one skilled in the art will appreciate that the dUE link terminals can be independent physical entities, that is to say with the necessary software resources and the necessary hardware resources to perform their function. In particular, the hardware resources in question comprise antennas, amplifiers, modems, or even a radio scanner etc. (namely, Tx/Rx) for the transmission and the reception of radio signals. Alternatively, however, at least some of the dUEs may be virtualized entities, and then use physical resources of the eNodeB of the improved base station to which they belong. Such a virtual terminal comprises software resources implemented in this improved base station, as well as hardware resources of said base station.

In particular embodiments of the invention, the direct mode links may be established in Sidelink mode on the PC5 interface, for example, as known in LTE standards (see chapter 9, from edition 12.5 of the LTE-A standard) for the direct communications between mobile terminals, called “device-to-device” communications in the LTE-A standard. The Sidelink mode and the PC5 interface were initially designed for security forces such as the police, firefighters and ambulances for applications in the field of professional mobile radio communications or PMR (from the English, “Professional Mobile Radiocommunications”). The Sidelink mode and the PC5 interface use radio resources originally allocated to the uplink communications, on an UpLink or UL-type link (namely, the modulation format of which is specific to the communications from a terminal to a base station), for allocating them to terminal exchanges between terminals in D2D direct mode.

However, the use of the Sidelink mode and the PC5 interface impose significant constraints in terms of the resources that can be used for these communications. In particular, the number of radio blocks (as will be explained below), the power or the throughput associated with a given communication are limited by LTE standards.

That is why, in a preferred embodiment of the invention, the communications in direct mode established between two improved base stations are not according to the Sidelink mode. Preferably, a proprietary protocol which can be presented as an alternative to the Sidelink mode of LTE standards, and which integrates specific modifications divesting from these standards, can be used instead. For example, it is possible to use radio resources originally allocated to the downlink communications, on a DownLink or DL-type link (namely, the modulation format of which is specific to the communications from a base station to a terminal), for the D2D direct mode link between two improved base stations. It is then possible to allocate more important resources, not limited by the relatively low throughput provided for these D2D mode communications in LTE standards, specifically for the direct mode communication established between two dUE link terminals respectively associated with improved base stations of two separate mobile structures.

More specifically, the allocation of radio resources dedicated to establishing a direct mode link is based on the use of radio resource units called “radio blocks” or RB (from the English, “Radio Block”). Indeed, traditionally, in communications between an eNodeB and one or more UEs, the frequency spectrum used is divided into radio blocks which are the primary unit of data transport resources, defined in frequency and/or time, used for radio communications. However, all or part of these radio blocks are not necessarily used by an eNodeB for the communications with the various UEs in its cell.

Thus, the invention includes using all or part of an RB. The notion of RB corresponds to a frequency*time division of the LTE in OFDM mode. The one skilled in the art will understand it may have another name depending on the technologies, but that the principle of application remains the same.

The resource used may then be only a part of this RB. In particular, the resource used is all or part of an RB originally dedicated to UL or DL data transfer for users of the Uu type (LTE) from a base station. In particular, the radio resources allocated may correspond to part of the RBs useful for the PUSCH and PDSCH (“Physical UL/DL Data Shared Channels”, in Anglo-Saxon terminology) functions.

The use of blocks radio advantageously allows to facilitate the segmentation of the resources, especially to dedicate only a part of said Radio Blocks to the mobile terminals (Uu communication) as a function of time. Thus, preferably, all or part of the Radio Blocks originally dedicated to UL or DL data transfer for users of the Uu type (LTE) from a base station is assigned to the direct mode link. This reallocation is almost transparent to the Uu users except for a possible reduction in throughput.

The invention therefore makes it possible for the dUE link terminals to divert the radio blocks the eNodeBs do not use to communicate with the UEs located in the same cell through their LTE-Uu interface, in order to use them for establishing a D2D direct mode link between two improved base stations. More precisely, the eNodeB base station included in the improved base station of each mobile structure excludes from its LTE-Uu communication interface radio blocks which can then be used to form a backhaul-type D2D direct mode link between the two mobile structures. These radio blocks may be contiguous with each other in the frequency domain and/or in the time domain (as in the example shown in FIG. 2 which will be described below), or be distributed in the frequency domain particularly the UL or DL frequency spectrum, and/or in the time domain among those that remain allocated to the LTE-Uu communication interface. As already mentioned above, all these radio resource allocation operations of the radio block-type can be controlled by the RRCE which is also included in the improved base station of each mobile structure according to the invention.

Finally, the invention therefore provides a system for the direct mode communication established between two separate mobile structures. The term system refers, within the meaning of this description, to all the improved base stations that interoperate on a same frequency spectrum. For example, some of the frequency spectrum divisions are used for standard communications in the context of a LTE network, and other divisions allow D2D direct mode communications to be established between two mobile structures. Thus, even when the radio link is lost with the EPC network core, mobile structures within radio range of one another can communicate with each other in D2D direct mode, thanks to what is backhaul-type links. The solution provided according to the embodiments of the invention for establishing direct mode links by “theft” of radio blocks normally reserved for the cellular communication interface (namely, the LTE-Uu interface in the example), has particularly the additional advantage of allowing links to be established for data exchange according to a radio interface (and especially a protocol) which can divest from LTE standards. In addition, this backhaul-type network can, for example, be built advantageously according to a mesh topography.

FIG. 2 schematically shows the distribution of the radio blocks used for the different communications that can be established by or with a mobile structure according to embodiments of the invention.

As already mentioned above, the frequency spectrum 201 is centered on a determined frequency F₀ and is divided into radio blocks 203. As illustrated by the arrow 204 symbolizing the time axis, originally these are only usable by the eNodeBs for the communications, established on the LTE-Uu interface, with the UEs present in their cell. Secondly, a part 203a of the radio blocks is allocated to the establishment of one (or more) direct mode (D2D) link(s) between the two UE link terminals belonging to the respective improved base stations of two separate mobile structures, while the other part of radio blocks 203b remains allocated to the communications, on the LTE-Uu interface, with the UEs located in the cell of the eNodeB and connected to this base station.

Advantageously, from the point of view of the UEs that are present in the cell of the eNodeB, this use of radio resources for establishing a D2D direct mode link with another mobile structure can be transparent. Indeed, when the radio resources used for the direct mode link are initially unused, no effect is perceptible for the “traditional” LTE network entities the UEs belong to.

The allocation of radio blocks for the direct mode communication between mobile structures, which is carried out by the eNodeBs of said mobile structures under the control of the RRCE entities, is static until a possible reconfiguration of the system. Indeed, this allocation of resources implies a prior configuration of each dUE. In addition, depending on the embodiments, the dUE may be a specific piece of equipment with its own radio channel or may be a virtual entity using the radio channel of the eNodeB included in the same advanced base station.

As already mentioned above, some embodiments allow to establish, from a mobile structure equipped with an improved base station, which is mobile, direct mode links with a plurality of other mobile structures. For example, in the case of a vessel establishing direct mode links with other vessels, it could establish more than 3, preferably more than 4, for example 6 direct mode links, especially in the case of an eNodeB including three cells, with each of said cells being capable of establishing two data transport links. Of course, the number of direct mode links cannot be limited to six links. Indeed, depending on the availability of the radio blocks of the dedicated user equipment, it will be possible to establish a larger number of links from a cell of an eNodeB.

In this case, the radio blocks that are excluded from the LTE-Uu communication link in order to be used for establishing the direct mode link between the respective dUEs of improved base stations, are first subdivided into 2, 3, 4 or 5 sets of radio blocks, for example, so as to establish direct mode links with 2, 3, 4 or 5 other vessels. This allows a backhaul network with a mesh topology to be built, for direct mode communication between the vessels in a fleet comprising two to six vessels within radio range of each other.

In a backhaul network configuration with a mesh topology, at least two mobile structures are located at a distance one from the other close enough to allow some of their radio equipment, and in particular, dedicated user equipment, to communicate with each other. This distance is defined by the respective transmission power of each of the radio equipment intended to establish communication links. However, each base station serves a geographical area defined by the extent of its radio coverage (namely, a radio coverage area, or cell), in which cellular radio communication links are established between said base station and respective mobile terminals. In addition, each radio coverage area of a given base station is likely to overlap partially or totally with a radio coverage area of another base station, due to the mobility of all or part of the base stations of the system. This may result in interference between radio communication links established by one base station, and those established by the other base station potentially on the same frequency bands.

A base station can thus be arranged so as to allow the regulation of the transmission power of base stations of third party mobile structures located in the immediate environment of each other, so as to reduce interference in the overlap area between the respective radio coverage areas of each base station, while optimizing the total radio coverage area served by the different base stations concerned. In addition, the base station can also be arranged to adapt the transmission power of the base stations of third party mobile structures in a situation where the different mobile structures are connected to each other by a direct mode communication link.

The one skilled in the art will appreciate that, depending on the specificities of each application, the eNodeB base station can allocate more radio resources in total (namely, more radio blocks RBs) to the direct mode links, by taking these RBs from the RBs originally usable for the links on the LTE-Uu interface, in order to ensure a better transfer rate for the direct mode communications between the base stations of the mobile structures. In particular, the allocation of radio resources to the direct mode links may be subject to the prior detection of third party mobile structures through a radio scanner of the mobile structure or the establishment of a backhaul-type data transport link that directly connects to each other the radio equipment of several mobile structures. This obviously requires knowing certain information about the other entities with which such a link can be established, in order to initiate the establishment and/or ensure the proper functioning of the link.

Such a mobile structure may thus comprise an on-board radio scanner having means for measuring a radio frequency signal transmitted in a specified frequency spectrum, by at least one third party mobile structure within range of said radio scanner of the mobile structure, and being configured to determine, based on physical properties of the measured radio frequency signal, information associated with the use of the determined frequency spectrum, for radio transmissions, transmitted by the third party mobile structure.

It is thus possible to detect the presence of a third party mobile structure, or to determine the separation distance from this third party mobile structure, also to determine the frequency radio resources used by all radio equipment located within range of the radio scanner of the mobile structure and finally, to identify, where appropriate, a third party mobile structure with which a backhaul-type data transport link can be established.

A mobile structure, equipped with a radio scanner, likely to establish such a link is capable of determining whether or not a third mobile structure, with which it could establish a data transport link, is within range of its own radio equipment. In other words, the mobile structure has means for knowing whether a third party mobile structure enters or exits an area, which is within range of the radio scanner, and in which said third party mobile structure is eligible for the establishment of a backhaul-type data transport link.

In addition, the mobile structure establishing a data transport link may also determine whether the third party mobile structure with which it establishes this link is moving away from it, approaching it or remains at a constant distance therefrom. This allows, on the one hand, the implementation of the data transport link to be optimized taking into account this distance and, on the other hand, the parameters of this link (such as the radio power) to be adapted to the distance actually separating the mobile structure from the third party mobile structure.

Secondly, when a third party mobile structure likely to establish such a link is detected in the environment, that is to say within radio range, of the mobile structure, a radio scanner equipping a mobile structure allows to identify this third party mobile structure. In particular, when the mobile structure is on board a first vessel and when the third party mobile structure is a piece of radio equipment on board another vessel, the identification may then condition any establishment of a backhaul-type data transport link between the two. Indeed, depending on whether the second vessel is a friendly, enemy or neutral vessel, the establishment of a backhaul-type data transport link may or may not be desirable.

Finally, the use of such a radio scanner allows to take into account information that is important for establishing an efficient backhaul-type data transport link, namely information relating to the use made of the frequency spectrum by the various radio equipment present in the immediate environment of the mobile structure. Indeed, the communications of a base station with the mobile terminals in its cell are carried out in a given frequency spectrum. This frequency spectrum, typically a frequency band standardized according to the LTE standard of the 3GPP consortium, consists in at least one frequency band with a determined central frequency and a determined spectral width. Since this frequency spectrum is used for several communications at the same time, distributing the useful available frequencies as efficiently as possible between the different communications becomes necessary in order to optimize the performance of each one and avoid or limit the occurrence of interference. However, this frequency spectrum can be used for the communications of each base station of each mobile structure with the terminals of its cell and also for establishing a backhaul-type data transport link between several mobile structures.

In other words, an optimal operation of a link of that type involves an optimized distribution of the radio resources used by all radio equipment within radio range of the mobile structure. However, an optimized distribution is based on a precise knowledge of the use of the frequency spectrum by all radio equipment within radio range of the mobile structure and likely to use all or part of this spectrum. The use of a radio scanner therefore allows a control entity to manage the use (especially the allocation) of the radio resources in the spectrum based on information obtained through said radio scanner.

In a particular embodiment, the direct mode links established between the link terminals of two separate mobile structures may involve data exchanges with asymmetrically sharing the transmission time of each link terminal, in the sense that the transmission time of one link terminal differs from that of the other link terminal. In one example, the fixed ratio is about two thirds of the time for one link terminal and about one third of the time for the other link terminal. In another particular embodiment, the link terminal associated with a given mobile structure can be configured to establish a plurality of backhaul-type direct mode links in a multicast configuration. This is in particular for the signaling necessary to establish exchanges, typically discovery and then identification, or even authentication. In such a configuration, a first link terminal is the sole transmitter of direct communications to the respective link terminals of the other structures with which direct mode links are established. A mobile structure can thus broadcast data simultaneously to a plurality of other mobile structures, without this involving a protocol-based data exchange such as, in particular, a multicast broadcast data transmission without any additional signaling required.

With reference to FIG. 3 will now be described embodiments for implementing a method according to the invention. The method is carried out by a system such as the one described above with reference to FIGS. 1 and 2. Preferably, each of the users (for example, mobile structure) of the system have been previously identified.

In a step 301, a first dUE link terminal of an improved base station of a given mobile structure, transmits a first message M1 called an identification/authentication message. This message is transmitted on radio resources of the advanced base station eNodeB included in the improved base station, of the radio block, RB, type, which are not usable for the communication link with the mobile terminals (via the LTE-Uu interface). This first message is intended to allow a direct mode link to be established with one or more other dUE link terminals, of another mobile structure. This first message is preferably transmitted in multicast mode for more efficiency.

During a second step 302, the link terminal transmitting the message M1 receives in turn a second identification/authentication message M2 from the dUE link terminal of the second improved base station of the mobile structure receiving the first identification/authentication message M1 transmitted.

In a third step 303, the data contained in the second identification/authentication message M2 is transmitted to an RRCE of the improved base station that comprises the dUE link terminal. This data is verified by the RRCE to establish its validity. For example, it can be compared with identification/authentication data included in a memory of the improved base station identifying the mobile structures that are allowed to establish a direct mode link with the structure the dUE link terminal in question belongs to. This data can be, for example, of the SIM (from the English, “Subscriber Identity Module”) type. In addition, the authentication data contained in the identification/authentication messages M1, M2 can be obtained from the HSS-type databases of the local EPCs of the various advanced base stations.

Finally, in a last step 304, after validating the authentication of the link terminal belonging to another structure (namely, after authenticating the mobile structure itself), a direct mode link adapted to be used as a link of a backhaul-type network is established between the first dUE link terminal and the second dUE link terminal of the other authenticated structure.

1. A communication system comprising at least two improved base stations each having mobile communication terminals and at least one base station which is adapted for establishing cellular communication links with said mobile communication terminals of the improved base station via a determined radio interface (LTE-Uu) by allocating radio resources to said cellular communication links among a set of available radio resources,
wherein each improved base station further comprises a link entity configured to establish a direct mode (D2D) link with the link entity of the other improved base station; and
wherein the base station of one of said improved base stations at least is configured to exclude from the allocation to cellular communication links, part of the available radio resources, and to assign radio resources thus excluded to the allocation to a direct mode (D2D) link established with the base station of another of said improved base stations through the respective link entities of said improved base stations, for exchanging IP protocol data between said base stations, via a radio interface separate from the radio interface used for the cellular communication links.

2. The system according to claim 1, wherein the radio interface is selected from any radio interface for allocating radio resources comprising Radio Blocks.

3. The system according to claim 1, wherein the link entity of each said improved base station is a link terminal comprising hardware resources and software resources of its own.

4. The system according to claim 1, wherein the link entity of each said improved base station is a link terminal comprising software resources implemented in the base station of said improved base station, as well as hardware resources of said base station.

5. The system according to claim 1, wherein the radio interface used for establishing a direct mode (D2D) link between the base station of one of said improved base stations and the base station of another of said improved base stations via the respective link entities of said improved base stations, comprises radio resources diverted from the downlink channels of the radio interface (LTE-Uu) used for the cellular communication links.

6. The system according to claim 1, wherein the base station of each said improved base station is configured to establish direct mode (D2D) links with the respective base stations of a plurality of other said improved base stations via the respective link entities of said improved base stations.

7. The system according to claim 6, wherein the link entities of the plurality of other said improved base stations form with each other a backhaul network for establishing a mesh topology.

8. The system according to claim 6, wherein the base station of one of said improved base stations is configured to establish a direct mode (D2D) link with the respective base stations of a plurality of the other said improved base stations, via the respective link entities of said improved base stations, in a multicast configuration.

9. The system according to claim 6, wherein the radio resources of the base station of one of said improved base stations which are excluded from the allocation to cellular communication links with mobile communication terminals of said one of said improved base stations, are subdivided into at least two sets of radio resources, which may be allocated for each set of radio resources to direct mode (D2D) links with the base station of a respective one of the other said improved base stations.

10. The system according to claim 1, wherein the links between the respective base stations of said improved base stations which are established in direct mode (D2D) via the link entities of said improved base stations, are used in half duplex mode with symmetrically or asymmetrically sharing the transmission and reception time for each link entity.

11. The system according to claim 10, wherein an one of said improved base stations further comprises a control entity which is configured to control the allocation, by the base station of said one of said improved base stations, of the radio resources of said base station both for the cellular communication links with mobile communication terminals of the one of said improved base stations by using the radio interface (LTE-Uu) of said base station, and for a direct mode (D2D) link for exchanging IP protocol data with the base station of at least one of said other improved base stations.

12. The system according to claim 11, wherein at least one of the improved base stations is placed on a mobile structure.

13. A method for establishing a link for exchanging IP protocol data between respective base stations of improved base stations each having mobile communication terminals and at least one base station which is adapted for establishing cellular communication links with mobile communication terminals of the improved base station via a determined radio interface (LTE-Uu) by allocating radio resources to said cellular communication links among a set of available radio resources, said method comprising the following steps:
transmitting by a link entity of a first of said improved base stations, a first identification/authentication message (M1) destined to a link entity of a second of said improved base stations, said message (M1) being transmitted by using radio resources of the base station of the first improved base station which belong to only a part of the radio resources of the base station of the first improved base station which are excluded from the allocation by said base station to cellular communication links with mobile communication terminals of said first improved base station;
receiving, by the link entity of the first improved base station, a second identification/authentication message (M2) which is transmitted in response by the link entity of the second improved base station by using radio resources of a base station of the second improved base station which are excluded from the allocation by said base station to cellular communication links with mobile communication terminals of the second improved base station;
transmitting, by the link entity of the first improved base station, the second identification/authentication message (M2) to a control entity of the first improved base station and verifying by said control entity the validity of the data associated with said second identification/authentication message (M2); and, in case of validity,
establishing a direct mode (D2D) link between the base station of the first improved base station and the base station of the second improved base station, through the respective linking entities of said first and second improved base stations, for exchanging IP protocol data between said base stations, by using radio resources, of the respective base stations, which are excluded from the allocation by said respective base station to cellular communication links with mobile communication terminals of said improved base stations.

14. The method according to claim 13, wherein the identification/authentication messages (M1, M2) exchanged between said link entities are based on data contained in HSS-type databases of local EPCs respectively included in the first and second improved base stations which comprise the base station and the mobile communication terminals of said first and second improved base stations, respectively.
